(19) United States
(12) Patent Application Publication
(10) Pub. No.: US 2009/0164060 A1
(43) Pub. Date: Jun. 25, 2009

(54) VEHICLE INSTABILITY DETECTION AND PREVENTION SYSTEM

(75) Inventors: Frederick O. Fortson, Whitmore Lake, MI (US); Chad Lehner, Howell, MI (US); John Svinicki, Jackson, MI (US); Anu Gupta, Burgettsrown, PA (US)

Correspondence Address: GIFFORD, KRASS, SPRINKLE,ANDERSON & CITKOWSKI, P.C, PO BOX 7021, TROY, MI, 48007-7021, US

(73) Assignee: Solidica, Inc., Ann Arbor, MI (US)

(21) Appl. No.: 12/371,654

(22) Filed: Feb. 16, 2009

Related U.S. Application Data
(63) Continuation-in-part of application No. 12/033,507, filed on Feb. 19, 2008.
(60) Provisional application No. 60/890,558, filed on Feb. 19, 2007.

(51) Int. Cl. G06F 7/00

(52) U.S. Cl. 701/35; 701/29

(57) ABSTRACT

An intelligent system and method detects and informs operators of unstable vehicle conditions. An accelerometer and gyro based micro-controller system dynamically computing the center of mass, speeds, positions, angles, stability factors, Velocity-Road Roughness Index, Dynamic Stability Function, and other parameters critical in determining the dynamics of vehicle motion. The apparatus may be integrated into an overall vehicle network and may incorporate a method for detecting and warning vehicle operators of unstable driving conditions which may include rollover, high velocity turns, sideslope conditions, rough roads, slip, and other dynamic events.

### REFERENCE TO RELATED APPLICATION

This application is a continuation-in-part of U.S. patent application Ser. No. 12/033,5077 filed Feb. 19, 2008, which claims priority from U.S. Provisional Patent Application Ser. No. 60/890,558, filed Feb. 19, 2007, the entire content of both applications being incorporated herein by reference.

### FIELD OF THE INVENTION

This invention resides in a microprocessor-controlled, self-calibrating, vehicle instability detection and alert system. The system actively measures parameters pertaining to vehicle motion to provide a visual and audio warning to the operator that is proportional to the vehicle instability conditions.

### BACKGROUND OF THE INVENTION

The advantages of vehicle rollover detection have long been recognized. According to U.S. Pat. No. 6,055,472, in order to allow for a timely and reliable recognition of a rollover event of a vehicle, the angular velocities of the vehicle about the yaw axis, the roll axis, and the pitch axis are measured by way of respective rotation rate sensors. A rollover event is signaled as having been detected if an angular velocity exceeds a definable threshold.

U.S. Pat. No. 6,496,763 describes a system for detecting imminent or occurring rollovers in a vehicle having at least one rollover sensor for detecting a vehicle rollover and for emitting a corresponding signal. At least one rotational wheel speed sensor is provided which emits a signal corresponding to the respective rotational wheel speed to a control unit which is indirectly or directly connected with the at least one rollover sensor. The control unit is constructed such that a triggering signal can be generated for a safety system on the basis of the rollover signal, taking into account the at least one rotational wheel speed signal.

In U.S. Pat. No. 7,057,503, a roll angular velocity sensor and a lateral velocity sensor are operatively coupled to a processor, which generates a signal for controlling a safety restraint system responsive to measures of roll angular velocity and lateral velocity. In one embodiment, the processor delays or inhibits the deployment of the safety restraint system responsive to a measure responsive to the measure of lateral velocity, either alone or in combination with a measure of longitudinal velocity. In another embodiment, a deployment threshold is responsive to the measure of lateral velocity. The lateral velocity may be measured by a lateral velocity sensor, or estimated responsive to measures of lateral acceleration, vehicle turn radius, and either longitudinal velocity or yaw angular velocity, wherein the turn radius is estimated from either a measure of steering angle, a measure of front tire angle, or measures of forward velocity from separate front wheel speed sensors.

U.S. Pat. No. 7,333,884 describes a rollover detection system for a vehicle that comprises at least one sensor for the detection of the angle of rotation of the vehicle and/or at least one angular rate sensor. An electronic control device connected to the sensors as well as at least one safety device which can be activated via the control device in the event of a rollover scenario detected with reference to the sensor data. At least one irreversible safety device and at least one reversible safety device are provided. The control device distinguishes between at least one stage of a lower degree of severity and at least one stage of a higher degree of severity of the rollover scenario in the detection of a respective rollover scenario with reference to the sensor data in order to activate at least one reversible safety device in the case of a lower degree of severity and to activate at least one irreversible safety device in the case of a higher degree of severity.

### SUMMARY OF THE INVENTION

This invention resides in a self-contained, intelligent system for detecting vehicle instability and unstable driving conditions such as rollover, high-velocity turns, sideslope driving, rough roads, slip, and other dynamic events. The system may include sensors operative to determine vehicle speed, road conditions, accelerations imparted on the vehicle due to large turns and tilts, and angular rates of turns. The system may be integrated into a vehicle data network and other analog systems.

The system may further include acceleration and angular rate sensors operative in multiple axes to measure accelerations, yaw, pitch, roll and other vehicle motion parameters such as position, angles, velocities, etc.

The system is microprocessor-based and operative to compute parameters that may include accelerations, speeds, positions, angular rates, center of mass, angles, stability factors, Velocity-Road Roughness Index, Dynamic Stability Function, and other parameters critical in determining the dynamics of vehicle motion. The system is further operative to correlate such parameters in a multidimensional algorithm to determine vehicle stability conditions.

In the preferred embodiment, the alert may be visual or audible, or electronically communicated to other systems that may or may not correspond to a level of instability or prescribed threshold. Instability can be qualitatively described in varying levels of the visual or audible alert that may include blinking, pulsing, colors, decibels, and other audio-visual aids. Additionally, the level of instability may be electronically communicated to other vehicle systems.

The system may further include memory for storing a digital record of the vehicle history. This memory is operative to support logistics, troubleshooting, training, and any other applications where vehicle history is required information. An optional network interface that allows the system to communicate as a node on a network.

A real-time clock may be incorporated for keeping time stamps in applications that may include data acquisition and control. The satellite positioning systems such as GPS and other interfaces may be included for position, date, time, velocity, heading, and other telemetric data such as that available on GPS devices.

### BRIEF DESCRIPTION OF THE DRAWING

FIG. 1 is a block diagram depicting the preferred embodiment of the invention.

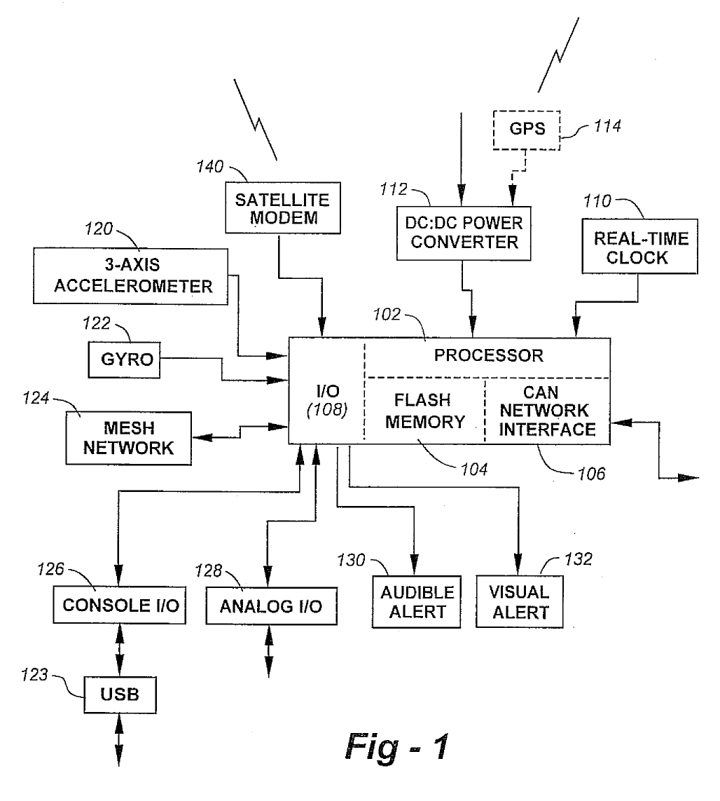

### DETAILED DESCRIPTION OF THE INVENTION

Referring to the FIGURE, the system employs a sensor suite to sense incipient vehicle instability conditions during the operation of a vehicle. As instability conditions are detected, a visual alert 132 and audio warning 130 are delivered to the vehicle occupants, and a digital record of the event may be captured in on-board memory. Audio warnings may be provided as voice announcements or as an audio tone from a built-in amplified speaker. Visual alerts may be provided by Light Emitting Diode (LED) Displays or any other suitable indicator.

In the preferred embodiment, accelerometers perform the function of measuring lateral, horizontal, and vertical accelerations to indicate vehicle motion, vehicle vibration, vehicle speed, and road roughness. Gyros 122 are used to sense angular velocities and angular accelerations in the vehicle's yaw, pitch, and roll axes.

Computation of data input from the accelerometer 120 and gyro 122 are performed by processor 102 that may include but are not limited to accelerations, speeds, positions, angular rates, center of mass, angles, stability factors, Velocity-Road Roughness Index (VRRI), Dynamic Stability Prediction, and other parameters critical in determining the dynamics of vehicle motion.

In the preferred embodiment, the VRRI is an empirically determined parameter that quantifies vehicle speed and road roughness into a single value. Accelerometers are used to measure vehicle vibrations which are proportional to speed and road roughness. This parameter may be compared to other measured quantities to determine vehicle instability.

In the preferred embodiment, the side slope instability function is computed by examining high lateral accelerations coupled with low vehicle speeds (VRRI) over a specified time period. This allows the system to differentiate between accelerations due to gravity in side slope conditions and centrifugal accelerations on level surfaces. Computation of instability conditions may also be performed for a stopped vehicle, as would be the case where a vehicle is ‘parked’ at an angle on a hillside and heavy equipment is loaded on top of the vehicle.

In the preferred embodiment, the Dynamic Instability Predictor is computed by correlating the VRRI to angular accelerations (also known as jerk). The combination of these two factors indicates when a vehicle is becoming unstable by entering a skid condition. The alarm is triggered as the yaw jerk exceeds the threshold for a given VRRI. A lateral acceleration function may also be included to determine if the vehicle could become unstable by exceeding some threshold of lateral acceleration for a specified amount of time.

Additionally center of mass predictors may be found by measuring the vibrational response of a vehicle and comparing against the response of a calibrated unweighted vehicle. This change vibration signature is nominally proportional to the change in weight of the vehicle and can be correlated to the change in the center of mass.

The system may use a real-time clock (RTC) 110 for keeping time and providing time stamping for such applications such as data acquisition and control operations. The RTC may be synchronized with an attached optional radio communication module 114 for enhanced accuracy. The RTC then will provide a highly accurate time base for the system in the event of a loss or jamming of a radio signal.

The system has optional support for electronically communicating with vehicle systems or networks.

The console I/O section includes a high-speed data interface 123 to directly connect to an optional computer for control, data acquisition, and data base applications. When used in conjunction with such software applications, the system can save all vehicle network and wireless network sensor data for forensic analysis of rollover events and warnings in real time.

We claim:

1. A system for detecting vehicle instability, comprising:
a multi-axis accelerometer operative to measure lateral, horizontal, and vertical accelerations of a vehicle;
one or more gyroscopes to sense angular velocities and angular accelerations with respect to the vehicle's yaw, pitch, and roll axes;
a processor operative to execute multiple algorithms to detect vehicle instability conditions including rollover, high-velocity turns, side slope conditions, rough roads, slip, and other dynamic events based upon inputs from the accelerometer or gyroscopes; and
wherein the accelerometer, gyroscopes and processor are disposed in a self-contained unit that does not require any external inputs or modification to the vehicle for the operation of the system.

2. The system of claim 1, wherein the processor is further operative to compute parameters at least including center of mass, vehicle speed, accelerations, vehicle position, vehicle angles, stability factors, Velocity-Road Roughness Index (VRRI) and Dynamic Stability Prediction.

3. The system of claim 1, wherein the accelerometers are operative to measure vehicle vibrations which are proportional to speed and road roughness.

4. The system of claim 1, wherein the processor is operative to:
derive VRRI as an empirically determined parameter that quantifies vehicle speed and road roughness into a single value; and
compare VRRI to other measured quantities to determine vehicle instability.

5. The system of claim 2, wherein the side slope conditions are computed by examining high lateral accelerations in conjunction with VRRI over a specified time period.

6. The system of claim 1, wherein one of the algorithms executed by the processor outputs a Dynamic Instability Predictor which is determined by correlating the VRRI to rapid changes in gyro accelerations.

7. The system of claim 1, wherein one of the algorithms executed by the processor includes a lateral acceleration function which correlates lateral acceleration and time against a calibrated value to determines if the vehicle could become unstable.

8. The system of claim 1, wherein the processor is further operative to determine changes in center of mass by measuring the vibrational response of a vehicle and comparing that against the vibrational response of a calibrated unweighted vehicle.

9. The system of claim 1, wherein the processor is further operative to detect incipient instability conditions during the operation of a vehicle.

10. The system of claim 1, further including an electronic interface enabling the system to communicate as a node on an existing vehicle network.

11. The system of claim 1, further including a real-time clock for keeping time stamps associated with data acquisition or control of the system.

12. The system of claim 11, further including a satellite positioning system or other interface enabling date and time to be coordinated and stored in conjunction with vehicle position, velocity, heading, and other telemetric data.
